(19) United States
(12) Patent Application Publication
(10) Pub. No.: US 2025/0348089 A1
(43) Pub. Date: Nov. 13, 2025

(54) INFORMATION PROVIDING SYSTEM AND INFORMATION PROVIDING METHOD

(71) Applicant: TOYOTA JIDOSHA KABUSHIKI KAISHA, Toyota-shi (JP)

(72) Inventors: Satoshi TOYOSHIMA, Toyota-shi (JP); Shiri ODA, Anjo-shi (JP); Takeshi MATSUI, Nisshin-shi (JP)

(73) Assignee: TOYOTA JIDOSHA KABUSHIKI KAISHA, Toyota-shi (JP)

(21) Appl. No.: 19/034,981

(22) Filed: Jan. 23, 2025

(30) Foreign Application Priority Data
May 8, 2024 (JP) 2024-075726

(51) Int. Cl. G05D 1/692; G05D 105/10; G05D 105/28; G05D 105/85; G06Q 10/0631

(52) U.S. Cl. CPC G05D 1/692; G05D 2105/10; G05D 2105/28; G05D 2105/85; G06Q 10/06315

(57) ABSTRACT

An information providing system according to the present disclosure inputs input information including information on a plurality of robot units that enable a robot to execute a plurality of different services by being used in combination with a certain robot that moves autonomously and another type of robot, information on a place and a time period in which the robot operates, and information on a type of a required service. The information providing system performs a calculation process of calculating, for each robot, information related to a resource amount for a robot and a plurality of robot units required for a service based on the input information, and outputs a result calculated in the calculation process.

### CROSS-REFERENCE TO RELATED APPLICATION

This application claims priority to Japanese Patent Application No. 2024-075726 filed on May 8, 2024, incorporated herein by reference in its entirety.

### BACKGROUND

### 1. Technical Field

The present disclosure relates to an information providing system and an information providing method.

### 2. Description of Related Art

WO 2023/86665 discloses an autonomous mobile robot that tows a wheeled cart.

### SUMMARY

A technique that allows a user to know a result of quantitatively comparing robot-related resources required for a plurality of types of autonomous mobile robots is desired. The technique described in Patent Document 1 is not a technique capable of addressing this issue.

An aspect of the present disclosure provides an information providing system that provides information about an autonomous mobile robot, the information providing system being configured to:
receive input information including information about a plurality of robot accessory units that enables the autonomous mobile robot to execute a plurality of different services when used in combination with the autonomous mobile robot, information about a plurality of robot accessory units that enables another type of autonomous mobile robot to execute a plurality of different services when used in combination with the other type of autonomous mobile robot, information about a location and a time zone in which the autonomous mobile robot or the other type of autonomous mobile robot operates, and information about a type of a service requested;
perform a first calculation process of calculating first resource information based on the input information, the first resource information being information about a resource amount for the autonomous mobile robot and the robot accessory units required for a service;
perform a second calculation process of calculating second resource information based on the input information, the second resource information being information about a resource amount for the other type of autonomous mobile robot and the robot accessory units required for a service; and
output a result calculated by the first calculation process and the second calculation process. The system may perform calculation using a machine learning model, for example.

An aspect of the present disclosure provides an information providing method for a computer to provide information about an autonomous mobile robot, the information providing method including:
receiving input information including information about a plurality of robot accessory units that enables the autonomous mobile robot to execute a plurality of different services when used in combination with the autonomous mobile robot, information about a plurality of robot accessory units that enables another type of autonomous mobile robot to execute a plurality of different services when used in combination with the other type of autonomous mobile robot, information about a location and a time zone in which the autonomous mobile robot or the other type of autonomous mobile robot operates, and information about a type of a service requested;
performing a first calculation process of calculating first resource information based on the input information, the first resource information being information about a resource amount for the autonomous mobile robot and the robot accessory units required for a service; performing a second calculation process of calculating second resource information based on the input information, the second resource information being information about a resource amount for the other type of autonomous mobile robot and the robot accessory units required for a service; and
outputting a result calculated by the first calculation process and the second calculation

According to the present disclosure, it is possible to provide an information providing system and an information providing method that allow a user to know a result of quantitatively comparing robot-related resources required for a plurality of types of autonomous mobile robots.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an overall configuration of a management system including an information providing system;

FIG. 2 is a block diagram illustrating a control system of the management system of FIG. 1;

FIG. 3 is a side view schematically showing a configuration before and after connection of the cleaning unit of FIG. 1;

FIG. 4 is a diagram illustrating an example of information input and output by the management system of FIG. 1;

FIG. 5 is a diagram illustrating an example of schedule information calculated by the management system of FIG. 1; and

FIG. 6 is a flowchart illustrating an information providing method according to the present embodiment.

### DETAILED DESCRIPTION OF EMBODIMENTS

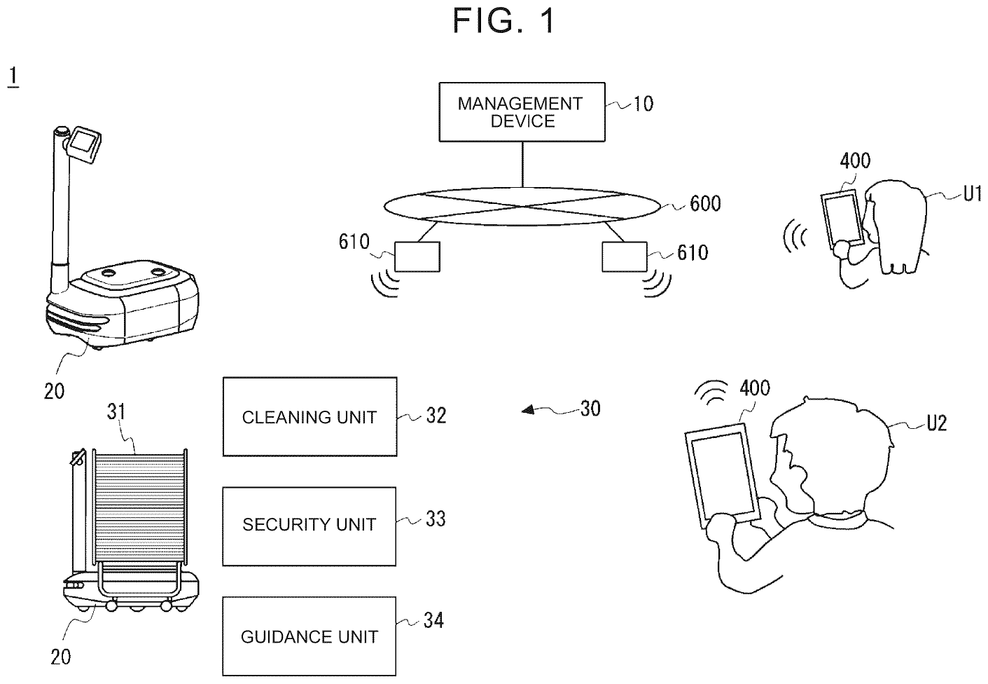

Hereinafter, the present disclosure will be described through embodiments of the disclosure, but the disclosure according to the claims is not limited to the following embodiments. Not all of the configurations described in the embodiments are essential as means for solving the problem. The information providing system according to the present embodiment is a system that provides information about an autonomous mobile robot. This information providing system can be incorporated in a management system that manages the operation of an autonomous mobile robot capable of executing a plurality of services (also referred to as tasks). As illustrated in FIG. 1, the management system 1 includes one or more robots 20, a management device 10, one or more units 30, a network 600, a communication unit 610, and a user terminal 400, and manages the robots 20 and the units 30. The unit 30 is a robot accessory unit used in combination with the robot 20 to execute each service. For example, the unit 30 is a transport unit 31 exemplified by a wagon that can be mounted on the robot 20 and can accommodate an article, a cleaning unit 32, a security unit 33, and a guidance unit 34 that can be mechanically connected to the robot 20. Of course, the unit 30 is not limited thereto. For example, a transfer robot including a wagon that can run together with the robot 20 and can accommodate an article, a cleaning robot and a security robot that can run together with the robot 20, and other service units may be managed by the management system 1. Hereinafter, an example in which the four types of units 30 are managed will be described, but one or more of the four types may not be managed.

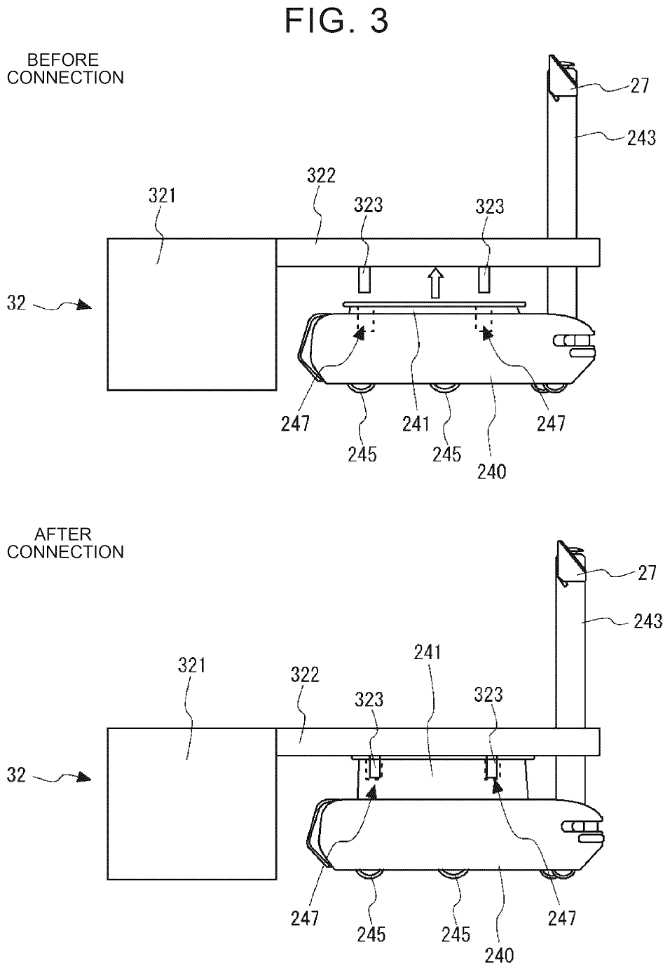

The robot 20 is an autonomous mobile robot, and executes a plurality of services such as transportation, cleaning, security, and guidance in a facility, for example. The facilities are medical welfare facilities such as hospitals, rehabilitation centers, nursing facilities, and residential facilities for the elderly, and commercial facilities such as shopping malls. The robot 20 includes wheels, a chassis, a motor, a sensor, a battery, a controller, and the like, and selectively mounts any one or more of the units 31 to 34 according to a service to be executed. The robot 20 has a configuration in which the unit 30 is mounted only by its own operation, or a configuration in which a user or the like assists in mounting. The transport unit 31 is a unit 30 for transporting a conveyed object. For example, the transport unit 31 is a wagon or a cart with wheels, and a conveyed object can be mounted in the wagon or cart. The bogie portion of the robot 20 serves as a stage on which a wagon or the like is mounted. The transport unit 31 may be used for serving a table at a restaurant, a medical welfare facility, or the like, transporting a part at a factory, transporting a sample at a hospital, transporting a linen at a hotel, or the like. The cleaning unit 32 is a unit 30 for cleaning a facility. The cleaning unit 32 includes a cleaner that sucks dust and the like. Alternatively, the cleaning unit 32 includes a pad, a mop, or the like for wiping the floor. The cleaning unit 32 may be a robot cleaner capable of remote control by wireless communication from the robot 20. The security unit 33 is a unit 30 for securing a facility, and includes, for example, various sensors for detecting an intruder or an abnormality. The various sensors include, for example, a camera, an infrared camera, a ranging sensor, an optical sensor, a thermal sensor, and a smoke sensor. The security unit 33 may include an illumination device that illuminates an intruder or an abnormal portion, an alarm function that notifies the intruder when an abnormality is detected, and the like. The guiding unit 34 is a unit 30 for guiding a facility. For example, the guidance unit 34 guides the visitor of the facility a route to the destination or the like. The robot 20 moves to the destination to guide the visitor. The guidance unit 34 includes an input device for a visitor to input a destination, such as a touch panel, a button, and a microphone for voice input. The guidance unit 34 may include a display device for displaying a route and a speaker for outputting a voice of the route. The guidance unit 34 may be a device that attaches to support 243 of FIG. 3 that is extended from the body of robot 20.

The usable unit 30 and the unusable unit 30 may be set according to the robot 20. A plurality of units 30 for one service may be provided. In the management system 1, for example, two or more transport units 31 may be provided in order for two or more robots 20 to simultaneously execute a transfer service using the transport unit 31. A plurality of types of units 30 may be prepared for one service.

The user U1 or the user U2 can use the user terminal 400 to make a service request such as a conveyance request for a conveyed object. For example, the user terminal 400 is a tablet computer, a smartphone, or an installation-type computer that can communicate wirelessly or wirelessly. The robot 20 and the user terminal 400 are connected to the management device 10 via a network 600 connected via a communication unit 610 such as a wireless LAN (Local Area Network) unit. The network 600 may be a wired or wireless LAN or WAN (Wide Area Network). Further, the management device 10 is connected to the network 600 by wire or wirelessly. The management device 10 is a server connected to each device, and collects data from each device. The management device 10 is not limited to a physically single apparatus, and may include a plurality of apparatuses that perform distributed processing, or may be distributed and arranged in an edge device such as the robot 20. The user terminal 400 and the robot 20 may directly transmit and receive signals. It is assumed that a plurality of robots 20 are used in a facility. The management device 10 assigns a service to each robot 20. Each of the robots 20 is equipped with a unit 30 corresponding to the assigned service, and executes the service. The service executed by the robot 20 may be inputted by a user U1 or a U2, or may be scheduled in advance. For example, a user U1 or the like operates the user terminal 400 to input the type of service to be executed, thereby making a service request. A user U1 or the like may enter an area, a time-zone, or the like in which the service is executed.

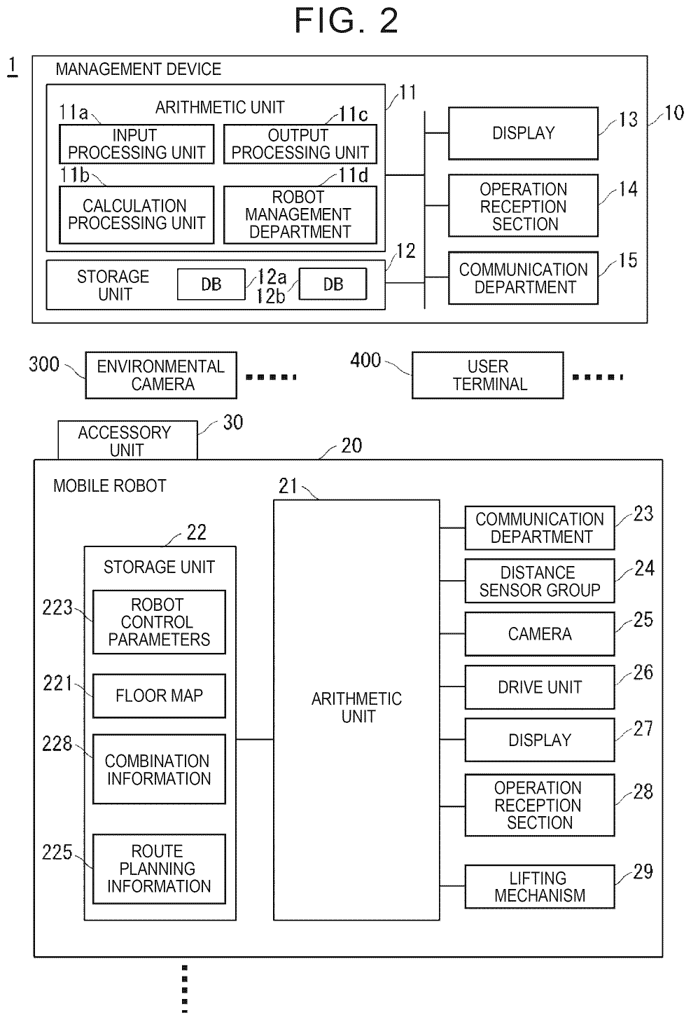

As illustrated in FIG. 2, the management system 1 includes a management device (higher-level management device) 10, a robot 20, a unit 30, an environment camera 300, and a user terminal 400. The management device 10 includes, for example, an arithmetic processing unit 11, a storage unit 12, a display unit 13, an operation reception unit 14, and a communication unit 15. In FIG. 2, some devices such as the network 600 and the communication unit 610 are omitted.

The arithmetic processing unit 11 may be implemented by a computer including a processor such as a CPU (Central Processing Unit), a working memory, a non-volatile storage device, and the like. The control program executed by the processor is stored in the storage device, and the processor reads the control program into the working memory and executes the read control program, whereby the arithmetic processing unit 11 can perform a function as described later. This storage device can also use the storage unit 12. The arithmetic processing unit 11 may be configured as a dedicated control circuit.

The arithmetic processing unit 11 includes a robot management unit 11d for controlling and managing the robot 20. For example, the robot management unit 11d receives a service request from the user terminal 400 or the like via the communication unit 15. The robot management unit 11d selects one robot 20 and a required unit 30 from the plurality of robots 20. The robot management unit 11d instructs the robot 20 to perform servicing via the communication unit 15 so that the robot 20 operates efficiently. The arithmetic processing unit 11 includes, for example, an input-processing unit 11a, a calculation-processing unit 11b, and an output-processing unit 11c for providing information about the robot 20. The management device 10 may be referred to as an information providing device.

The information providing system according to the present embodiment is not limited to the example used in the operation stage, and may be used before the operation of the autonomous mobile robot, that is, before the introduction of the autonomous mobile robot. When the information providing system is not incorporated in the management system 1, for example, the information providing system may be configured by a device having a configuration excluding the robot management unit 11d in the management device 10, or may be configured by the device and a user terminal. In this case, the user terminal in the information providing system may be a user terminal different from the user terminal 400 used in later operation.

The storage unit 12 includes a storage device such as a memory, a hard disk drive, or a SSD (Solid State Drive). The storage unit 12 stores various types of information, such as a database (DB) 12a, 12b, which will be described later. The communication unit 15 is a communication interface that communicates with other devices.

The display unit 13 is a display device that displays information. The operation reception unit 14 is an input device such as a keyboard or a pointing device. The display unit 13 and the operation reception unit 14 may be realized by, for example, a touch panel display. In this instance, the display unit 27 displays user interface (UI) images. For example, when the management device 10 is operated from the user terminal 400, the display unit 13 and the operation reception unit 14 may not be provided in the management device 10.

In the management system 1, the robot 20 performs route planning based on the service information. Based on the route plan information created by the robot 20, the robot autonomously moves toward the destination. The robot 20 autonomously moves toward a destination using a sensor, a floor map, position information, and the like provided in the robot itself. The robot 20 includes, for example, an arithmetic processing unit 21, a storage unit 22, a communication unit 23, a distance sensor group 24, a camera 25, a drive unit 26, a display unit 27, and an operation reception unit 28. The arithmetic processing unit 21 can be implemented as a device having a hardware configuration similar to that of the arithmetic processing unit 11 and capable of executing a control program. The communication unit 23 is a communication interface for communicating with the management device 10, the environment camera 300, or another robot 20. The communication unit 23 communicates with the communication unit 15 and the like of the management device 10 using, for example, a wireless signal. The distance sensor group 24 includes, for example, a proximity sensor, and outputs proximity object distance information indicating a distance to an object or a person existing around the robot 20. The camera 25 captures an image for grasping a situation around the robot 20, for example. The robot 20 may identify a surrounding object based on an image of the camera 25 or the environment camera 300. The environment camera 300 is a camera such as a surveillance camera installed in a plurality of passages, halls, elevators, entrances, and the like in a facility where the robot 20 travels. The management device 10 or the robot 20 can acquire an image of the moving range of the robot 20 from the environment camera 300. The drive unit 26 includes a motor that drives drive wheels provided in the robot 20. The robot 20 detects its current position and transmits it to the management device 10. The display unit 27 and the operation reception unit 28 are realized by a touch panel display. The display unit 27 displays UI images, and the operation reception unit 28 accepts an operation from the user. The operation reception unit 28 includes various switches provided in the robot 20. Information indicating a destination and a state of the robot 20 and various kinds of guidance information may be displayed on the display unit 27. The lifting mechanism 29 lifts and lowers a carriage unit for mounting the transport unit 31. The lifting mechanism 29 includes an elevating stage and a motor for raising and lowering the elevating stage.

The storage unit 22 includes a storage device similar to the storage unit 12, and stores, for example, a floor map 221, robot control parameters 223, combination information 228, and route plan information 225. The floor map 221 is map information of a facility for moving the robot 20, and may include, for example, position information of a charging facility for charging the robot 20. The floor map 221 may be downloaded from the management device 10, for example. The route plan information 225 includes route plan information planned by the arithmetic processing unit 21, and may include, for example, information indicating a destination, route information to a destination, service information inputted from a user U1, and the like. The combination information 228 includes information regarding a plurality of combinations of the robots 20 and the units 30 that are connectable to each other. The combination information 228 includes, for example, as a connection method between the robot 20 and the unit 30, information indicating any one of an elevating operation, a connection operation, and a connection by a wireless signal.

In the connection by the elevating operation, the robot 20 operates the lifting mechanism to mount the unit 30. For example, when the robot 20 raises the elevating stage by the lifting mechanism 29 in a state where the elevating stage is directly below the transport unit 31, the transport unit 31 is mounted on the robot 20 as illustrated in FIG. 1. As illustrated schematically in FIG. 3, the cleaning unit 32 may be connected to the robot 20 by an elevating operation, as the configuration before and after the connection of the cleaning unit 32 is schematically illustrated. The cleaning unit 32 includes a vacuum cleaner 321, a support portion 322, and a fixing pin 323. The vacuum cleaner 321 is connected to the support portion 322, and a fixing pin 323 is provided below the support portion 322. The fixing pin 323 is a convex portion protruding to the lower side of the support portion 322. The vacuum cleaner 321 may be configured to rotate a mop attached to suction or a lower portion of the mop while rotating, for example, along a vertical axis. The robot 20 includes a chassis 240 provided with wheels 245 and an elevating stage 241, and a display unit 27. A recess 247 into which the fixing pin 323 is inserted is provided on the upper surface of the elevating stage 241. The recess 247 is provided at a position corresponding to the fixing pin 323. At an end portion of the chassis 240, a support 243 is provided which extends upward from the cart 240 and on which a touch panel display serving as a display unit 27 or the like is installed. The robot 20 moves to the lower side of the support portion 322, more specifically, the chassis 240 moves directly under the support portion 322, raises the elevating stage 241, and the fixing pin 323 is inserted into the recess 247, whereby the cleaning unit 32 is connected to the robot 20. When the robot 20 runs to push or pull the cleaning unit 32, a cleaning service is performed. The transport unit 31 shown in FIG. 1 may also be mounted on the robot 20 with a configuration similar to that of the cleaning unit 32.

In the connection by the coupling operation, a coupling mechanism such as a hook mechanism, a locking mechanism, an engagement mechanism, a projection, a pin, a traction arm, a hole, a guide mechanism, or a joint mechanism is provided for coupling to one or both of the robot 20 and the unit 30. As the robot 20 travels and approaches the unit 30, the robot 20 and the unit 30 are connected to each other. A configuration may be adopted in which a user or the like assists in the connection operation. In the wireless signal connection, the robot 20 transmits a wireless signal to the unit 30 by, for example, Bluetooth (registered trademark) or the like. In this case, for example, the unit 30 is a cleaning unit including a cleaning robot.

The robot control parameter 223 is a parameter used for controlling the operation of the robot 20, and includes speed information regarding a speed such as a threshold distance for avoiding contact between the robot 20 and a surrounding object, a speed upper limit value, and the like, a height of the lifting mechanism, a turning radius, and the like.

Upon receiving a service request from the user terminal 400 or the management device 10, the arithmetic processing unit 21 identifies one or a plurality of units 30 to be used based on the combination information 228 and generates a control signal for executing the combination. The arithmetic processing unit 21 performs a route plan for executing the service. For example, the arithmetic processing unit 21 searches for a route to the area where the service is performed or a route in the service, obtains a movement route in the floor map 221, and writes the movement route in the storage unit 22 as the route plan information 225. The arithmetic processing unit 21 extracts a movement command from the control signal and the route plan information 225 given from the management device 10, and controls the drive unit 26 to perform a connection with the unit 30, an autonomous movement toward a destination or a waypoint based on the movement command. The arithmetic processing unit 21 may measure the relative position of the robot 20 with respect to the unit 30 from the detection result of the distance sensor group 24, the image of the camera 25 or the environment camera 300, and perform the alignment of the robot 20 with respect to the unit 30.

Next, a function of providing information of the robot 20 in the management device 10 will be described. The input processing unit 11a performs processing of inputting input data. The input information input person can be a merchant who sells the robot 20 or the unit 30, or a user of a facility operating the management system 1. This input can be performed while UI images for input are displayed on the display unit 13 from the operation reception unit 14, but can also be performed from the user terminal 400 via the communication unit 15, for example. This input may include text input, touch panel input, choice input, speech input, and input by speech response to artificial intelligence. The input information includes unit information that is information about the plurality of units 30, operation location information that is information about a place where the robot 20 operates and a time zone, and time zone information, and type information that is information about a type of a required service. However, the unit information in the input information is stored in advance in the storage unit 12 or the like without being input by the input person, and it is necessary to read the unit information at the time of calculation in the calculation processing unit 11b. The unit information includes first unit information related to a plurality of units 30 used in combination with a certain robot 20, and second unit information related to a plurality of units 30 used in combination with another type of robot 20.

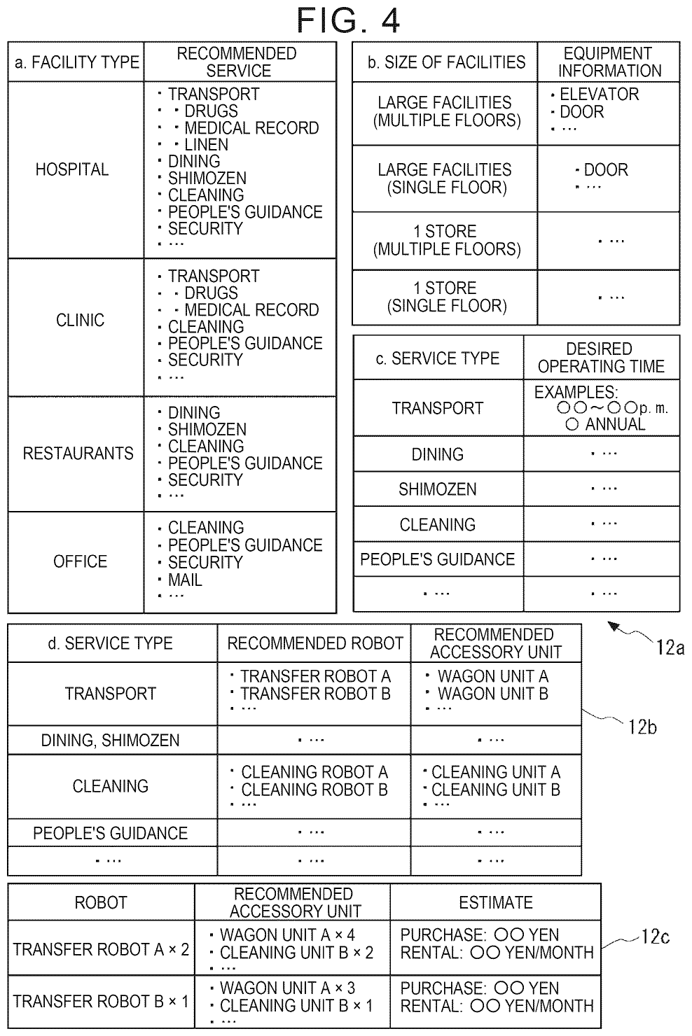

The respective unit information may be a DB 12b such as the table d shown in FIG. 4, and may include the type of the robot 20 recommended for each service type and the type of the recommended unit 30. That is, each unit information may include information indicating a service that can be provided by the unit 30 and information indicating the robot 20 to be attached. The different plurality of services may include at least two of transportation, patrol security, and cleaning services. The information indicating the service that can be provided by the unit 30 may include, for example, the same cleaning unit, or information indicating the service for each detailed use so that the cleaning unit A for carpet cleaning, the cleaning unit B for tile cleaning, and the like can be distinguished. Each unit information may include information indicating the size of each unit 30 or each robot 20, and the like, and thus, each device recommended according to the operation location information and the type information can be limited based on the size. Each unit information may also include information indicating the purchase cost, rental cost, operation cost, and the like of each of the robot 20 and the unit 30. At least one of the robot 20 and the unit 30 included in each unit information is not limited to that of the same manufacturer. If it is already in the operation stage, each unit information may include information indicating the type and the number of the robots 20 and the units 30 in operation.

The information source of each unit information, that is, the acquisition source may be the storage unit 12. The input processing unit 11a may input the unit information by automatically selecting DB 12b stored in the storage unit 12 at the time of calculating the resource information. Alternatively, the input processing unit 11a may input the unit information by selecting one of DB prepared according to the performance of the robot 20 or the unit 30 by the input person. The acquisition source may be an external device connected to the management device 10. The source may be one or more external Web servers or the like. In this case, the input-processing unit 11a searches for the unit information and acquires the search result.

The type information is information related to the type of service desired by an input person to be executed by a certain robot 20 or another type of robot 20 in the facility. The type information may include information such as a service type, a service execution frequency, a service execution range within a facility, a service execution time, and the like. The execution time may include a time zone, a period, and the like in which the input person desires to operate. The type information may include the information itself related to the unit 30 used for the service.

The time period information is information related to a time period in which a certain robot 20 or another type of robot 20 operates with the unit 30 and provides a service that the unit 30 can provide, and is, for example, information described as the execution time. For example, the time zone information may be information in which the respective services such as transportation, cleaning, security, and guidance are sorted for each time zone, and may be different information depending on the day of the week or the like. The time zone information and the type information may be schedule information in which a time zone is stored for each type of service required. The schedule information may be calculated based on, for example, type information and operation location information.

The operation location information may include information indicating a size such as one or more pieces of information such as a size of an operation location, a site area, a floor area, and the like. The operation location information may include information such as a facility name or an address of a web page of the facility, which specifically indicates a facility to be introduced. When an address is entered, the address can be accessed to obtain information about the facility from the web page. The information indicating the size may simply include information indicating a facility type (a category or a type of a facility) such as a general hospital or a personal clinic, or may include information indicating a size, an area, a rank, or the like of the facility. Information showing size may include information showing, for example, the number of beds, employees, the number of doctors, the number of caregivers, and the number of sick persons.

In the following, the operation location information and the type information are inputted based on DB 12a stored in the storage unit 12. As shown in FIG. 4, DB 12a includes, for example, a table a, b, c. The input person appropriately selects the operation location information and the type information to be included in the input information based on the information indicated in DB 12a. Of course, the operation location information and the type information may be selected from data other than the facility type, the facility size, and the service type indicated in the table a, b, c. For example, the operation location information and the type information may include data of a facility type, a facility size, and a service type other than the data indicated in the table a, b, c as selection targets. Alternatively, at least part of the data indicated in the table a, b, c may not be included in the selectable operating location information and type information.

In the table a, the operation location information is a facility type for introducing a mobile robot. For example, the input person selects one of a hospital, a clinic, a restaurant, and an office as the facility type. In the example of the table a, for example, when the facility type is a clinic, a service such as transportation, cleaning, guidance of a person, security, and the like is shown in UI images, and the input person can select the facility type while confirming the service, and the selected facility type is input as the operation location information. Alternatively, for example, when the input person selects the clinic as the facility type, the clinic is input as the operation location information, and services such as transportation, cleaning, guidance of a person, and security are input as the type information. As described above, when the selection input of the facility type is performed, the input processing unit 11a can input the facility type as the operation location information, or can further input the recommended service corresponding thereto as the type information. Even in this case, the input of the desired operation time shown in the table c may be accepted. In the table b, the operation location information is the facility size of the facility in which the robot is introduced. The input person selects and inputs, for example, whether the facility scale is a large facility on a plurality of floors, a large facility on a single floor, one store on a plurality of floors, or one store on a single floor. In the example of the table b, for example, when the facility scale is a large facility (a plurality of floors), facility information indicating facilities such as an elevator and a door is shown in UI images, and the input person can select the facility scale while confirming the facility scale, and the selected facility scale is input as the operation location information. Alternatively, for example, when the input person selects a large facility (a plurality of floors) as the facility scale, the large facility (a plurality of floors) is input as the operation location information. Selection of facility information such as number and size of elevators and doors is also accepted. The facility information is also input as the operation location information. Depending on the size of the elevator or door, the size of the robot 20 recommended at the time of output is limited. As described above, when the selection input of the facility size is performed, the input processing unit 11a can input the facility size as the operation location information, or can also input the facility information corresponding to the facility size as the operation location information. The input person may input both the facility type and the facility scale as the operation location information. In other words, the input person may input the operation location data from both of the table a, b. The operation location information may include, for example, a floor map to be used in operation as the floor map 221.

In the table c, the type information is a service type indicating the type of the service executed in the facility. For example, as the type information, the input person selects and inputs one or a plurality of services to be executed in the setting from among conveyance, table setting, lower table, cleaning, and guidance of a person. The type information may include detailed information about the executable service content. For example, the cleaning service may be distinguished by information indicating whether the floor surface to be cleaned is a carpet, a tile, or both. The transportation service may be distinguished by information indicating a transportable transported object. More specifically, the type information may include information indicating which of a plurality of types of conveyed items, such as a medicine, a medical record, a linen, and a patient, among the conveyed items among the conveyed services. The medical article may include a specimen, or the specimen may be handled as a transported article separate from the medical article. There may be units in which the type of transport unit 31 can accommodate and lock the transport objects, and units in which it is not. In this case, the type information may include information indicating whether the transportation service is a service for transporting an important transportation object such as a medicine or a medical record or a service for transporting another transportation object as a transportation service. The type information may include information selected from a plurality of different services depending on the weight and size of the transportable object as the transportation service. The type of the transport unit 31 may be a wheelchair-type robot or a stretcher-type robot that conveys a patient. In this case, the type information may include information indicating whether the transportation service is a service for transporting a patient or a service for transporting another transported object as a transportation service.

Further, the input person inputs a desired operation time of the service, that is, an execution time, such as a time period in which operation is desired, for example, from 10:00 to 21:00, a period in which operation is desired, for example, for 5 years. The desired operating time may include information about the operating time, operating area, operating range, and operating speed at which the robot 20 and unit 30 perform the service. For example, the desired operating time may include information regarding the cleaning area per hour, the security area, the guidance distance, or the transport distance. Alternatively, the movable range may include information about the width of the passage, information indicating whether or not the vehicle is movable by the elevator, or information indicating whether or not the vehicle can be used outdoors. Note that the operation area and the operation range may be included in the operation location information instead of the type information.

The calculation processing unit 11b performs calculation processing of calculating resource information, which is information related to resource amounts of the robots 20 and the plurality of units 30 required for the service, based on the input information thus input. This calculation process is executed for a plurality of types of robots 20. Although the calculation method is not limited, the calculation processing unit 11b selects and determines the type and the number of recommended robots 20 and units 30 corresponding to the service indicated by the input unit information based on the input operation location information, type information, and time-zone information. Each resource information calculated for the plurality of types of robots 20 may include, for example, a required number and types of the robots 20 and the units 30, and may include a total amount thereof. Therefore, in the operation stage, additional necessary resource information may be calculated by subtracting the type and number of devices such as the robot 20 and the unit 30 in operation indicated by each unit information. The resource amount may include a resource amount for other devices such as a server device such as the management device 10 necessary for managing the robot 20 and the unit 30. The resource amount may include a resource amount indicating the number of persons or a total number of persons necessary for using the robot 20 or the unit 30, requirements such as skills required for the persons, a necessary training period, a necessary type of training, a necessary personnel cost, and the like. That is, the calculation process may calculate information including information on the amount of resources of a necessary person on the basis of the input information as part of the resource information. In the calculation process, the resource information may be calculated for each of a plurality of combinations of the robot 20 and the unit 30 required for the service based on the input information. That is, the calculation process may calculate not only resource information of one pattern but also resource information of a plurality of patterns, that is, information indicating a plan of a plurality of combinations. The total amount may include an introduction cost such as an initial cost and an operation cost such as a running cost including a maintenance cost, and the operation cost may include a personnel cost. The total amount may be a monthly cost such as a subscription by rental or the like or a yearly cost. When the desired operation time is input as the type information, the total amount may be an expense corresponding to the desired operation time. The total amount for each robot 20 may include the installation cost per unit 30. The calculation processing unit 11b may calculate information indicating a service that can be provided by the robot 20 alone without the unit 30 by including information in the resource information, for example, when the robot 20 is a transfer robot A having a lockable storage unit.

The output processing unit 11c outputs, as output destinations, a designated device such as the user terminal 400, an external server device (not shown), or a printing device (not shown), the calculation result in the calculation processing for the respective robots 20. The output-result may include, for example, the number of robots 20 to be recommended, the type and the number of units 30 to be recommended, as in the table 12c shown in FIG. 4, and may include at least one of the purchased amount and the rented amount when the recommended device is introduced as an estimate. As illustrated in the table 12c, the recommendation unit 30 and the estimates for the robots 20 may be outputted so as to be comparable. In the table 12c, the calculation processing is performed on the two types of robots 20, and the result is output, but the combination of the plurality of types of robots 20 may be set as one set, the calculation processing may be performed on the plurality of sets, and the result may be output. The output result may include detailed information about the executable service content. For example, in a case where the robot 20 is a robot capable of supporting conveyance and the unit 30 is a wagon unit, the detailed information may include information indicating a conveyable object. For example, in a case where there is a plurality of types of transported items, such as a medicine, a medical record, and a linen, the detailed information may include information indicating whether or not each transported item is transportable. The detailed information may include information on the weight and size of the transportable object. For example, since the transfer robot A can lock the storage portion of the conveyed object, it transports important conveyed objects such as medicines and medical records. The transfer robot B is a wheelchair-type robot or a stretcher-type robot that conveys a patient. The wagon unit A is an accessory unit for carrying linen. The wagon unit B is an accessory unit for transporting corrugated cardboard, fixtures, and the like. The detailed information may include such information. The detailed information may include information about the cleanable floor surface, such as, for example, information indicating that the cleaning unit A is a unit for carpet cleaning and the cleaning unit B is a unit for tile cleaning.

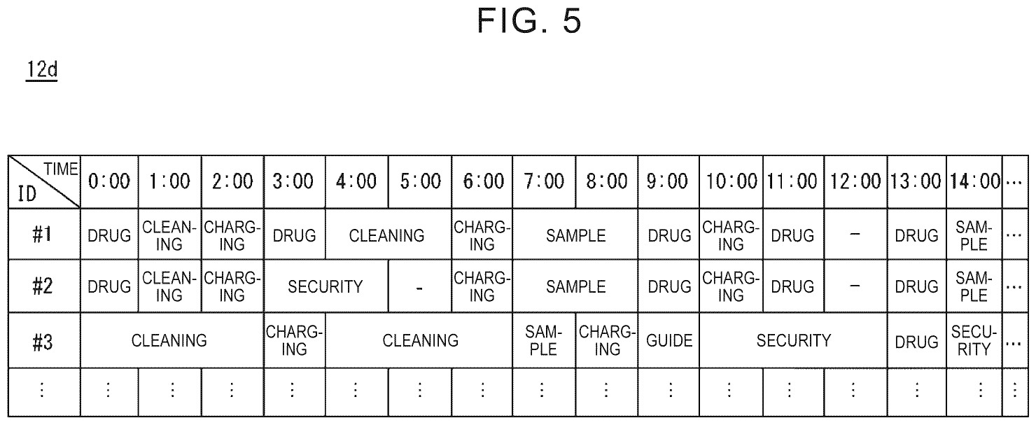

Alternatively, since the time zone is included in the desired operating time or the time zone information, the calculation processing unit 11b may calculate the schedule information based on the inputted information and calculate the resource information based on the schedule information. This scheduling information is generated so as to include operational shifts of a plurality of robots 20 and units 30 of a certain type, for example, the table 12d shown in FIG. 5, and can be referred to when the resource information is calculated. The operation shift can be calculated based on the above-described input information, for example, taking into consideration predetermined constraints such as the continuous operation time of each robot 20, the time required for charging, and the number of devices that can be prepared excluding the devices during charging or maintenance. This constraint condition may be included in the unit information and input. The table 12d is calculated based on the unit data of the plurality of types of robots 20 as follows. Each of the mobile robots #1 and #2 is capable of executing a cleaning service, a transfer service of a sample and a drug, and none of the mobile robots is compatible with a transfer service such as linen or a person. The mobile robot of #3 can execute all of those services. In the table 12d, charging indicates that the mobile robots are stopping at the charging station, charging the battery, and not performing servicing. Schedule information can be similarly calculated for other sets of the plurality of types of robots 20.

The calculation processing unit 11b may use a first model for inputting input information and outputting schedule information in calculating resource information of each mobile robot or each set, and a second model for inputting schedule information and outputting output information. Each of the first and second models can be a machine learning model such as deep learning, but the algorithm is not limited. The first model may be a model in which a data set including input information and correct answer data of schedule information for each input information is machine-learned. The second model may be a model in which a data set including correct answer data of the schedule information and the output information for each schedule information is machine-learned. The calculation processing unit 11b may use a machine learning model, such as deep learning, for inputting input information and outputting output information in the calculation of resource information regardless of whether or not the calculation of scheduling information is performed. Regardless of the algorithm of this model, the model may be a model in which a data set including correct answer data of input information and output information for each input information is machine-learned. The input information may include, for example, a floor map to be used in operation as the floor map 221. In such cases, the calculation processing unit 11b may use a machine-learning model suitable for image-recognition such as CNN (Convolutional Neural Network).

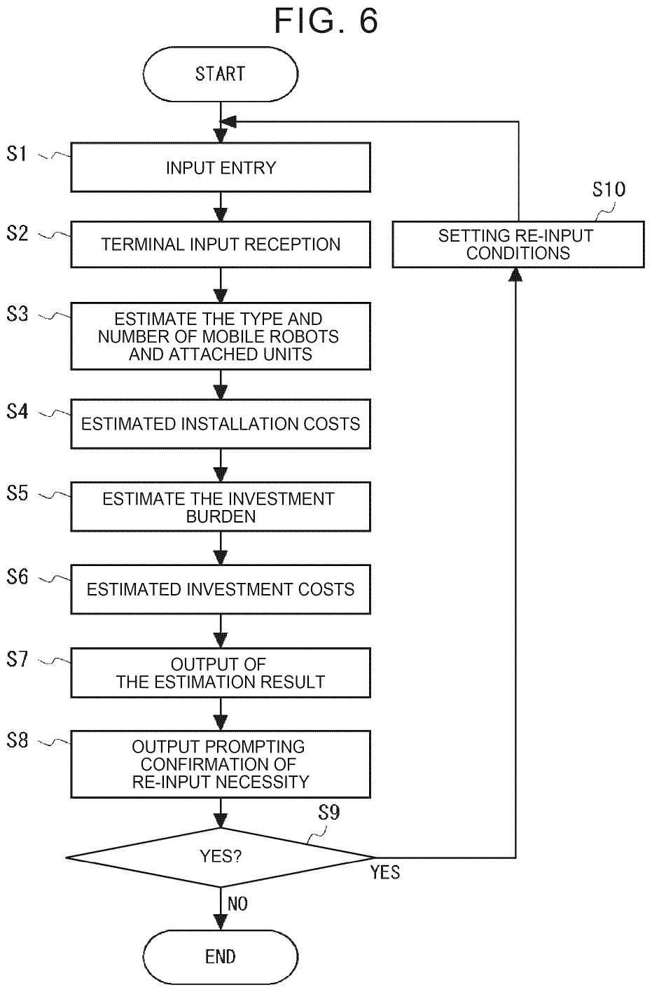

An example of an information providing method will be described with reference to FIG. 6. First, the input processing unit 11a receives an instruction from the user terminal 400 to start processing, and inputs unit data such as a DB 12b (S1). Next, the input processing unit 11a causes the user terminal 400 to display UI images in which DB 12a on the operation location information, the time-zone information, and the type information are read, and accepts input of these pieces of information from the input person at the user terminal 400 (S2). Then, the calculation processing unit 11b calculates the types and the numbers of the certain robots 20 or the certain sets and the required units 30 as the resource information based on the inputted information, thereby performing these estimations (S3). The calculation processing unit 11b estimates the cost of purchasing or renting according to the estimation (S4). The calculation processing unit 11b estimates the cost burden required for the operation based on the estimation result (S5), and estimates the operation cost that is the running cost (S6). The output processing unit 11c outputs the estimation results to the user terminal 400 (S7). The output processing unit 11c outputs, to the user terminal 400, a UI picture prompting the necessity of re-inputting the operation location information and the type information together with the result of the estimation or after outputting the result (S8). The output processing unit 11c determines whether or not there is an answer to S8 (S9), and ends the processing if there is no answer. If a S9 answer is received, the input processing unit 11a sets the re-input condition (S10). In S10, candidates for re-input items in the input information, such as the type of the robot 20, the set of the robot 20, and the desired operating hours, are set in advance. Then, the user terminal 400 generates or reads out UI images for inputting information about each of the candidates, thereby setting the re-input condition. After S10, the process proceeds to S1 process and resumes from specifying the unit data, and finally the output-result for the re-input condition is obtained. If the type or set of the robots 20 is not included in the re-input condition, S10 may be followed by S2 process. Note that S8-S10 process may be omitted, and S1-S7 process may be executed at a time for all of the types of the robot 20 or the sets of the robots 20. Separately, the cost in the case where the robot 20 and the unit 30 are not introduced may also be calculated so as to be comparable to the case where the robot is introduced.

The information providing system can calculate and output a plurality of pieces of information about a required robot and an attached unit according to a time constraint, a space constraint, and a size of a traveling environment of the mobile robot. According to the present embodiment, it is possible to realize a system that allows an input person serving as a user to quantitatively compare required robot-related resources for a plurality of types of autonomous mobile robots, thereby assisting the determination of the introduction of the robot and the decision of the use determination for a certain period. Part or all of the processing in the management device 10, the robot 20, the user terminal 400, and the like can be realized as a computer program. The program includes instructions (or software code) that, when loaded into a computer, cause the computer to perform one or more of the functions described in the embodiments. The program may be stored on a non-transitory computer-readable medium or a tangible storage medium, or may be transmitted on a transitory computer-readable medium or a communication medium, such as an electrical, optical, acoustic, or other form of propagated signal. The present disclosure is not limited to the above embodiments, and can be appropriately modified without departing from the spirit.

What is claimed is:

1. An information providing system that provides information about an autonomous mobile robot, the information providing system being configured to:
receive input information including information about a plurality of robot accessory units that enables the autonomous mobile robot to execute a plurality of different services when used in combination with the autonomous mobile robot, information about a plurality of robot accessory units that enables another type of autonomous mobile robot to execute a plurality of different services when used in combination with the other type of autonomous mobile robot, information about a location and a time zone in which the autonomous mobile robot or the other type of autonomous mobile robot operates, and information about a type of a service requested;
perform a first calculation process of calculating first resource information based on the input information, the first resource information being information about a resource amount for the autonomous mobile robot and the robot accessory units required for a service;
perform a second calculation process of calculating second resource information based on the input information, the second resource information being information about a resource amount for the other type of autonomous mobile robot and the robot accessory units required for a service; and
output a result calculated by the first calculation process and the second calculation process.

2. The information providing system according to claim 1, wherein the different services include at least two of a transport service, a patrol service, and a cleaning service.

3. The information providing system according to claim 1, wherein:
the robot accessory units to be used in combination with the autonomous mobile robot include at least two of a wagon mountable on the autonomous mobile robot and capable of accommodating an article, a cleaning robot mechanically connectable to the autonomous mobile robot, a patrol robot mechanically connectable to the autonomous mobile robot, a transport robot capable of traveling along with the autonomous mobile robot and including a wagon capable of accommodating an article, a cleaning robot capable of traveling along with the autonomous mobile robot, and a patrol robot capable of traveling along with the autonomous mobile robot; and
the robot accessory units to be used in combination with the other type of autonomous mobile robot include at least two of a wagon mountable on the other type of autonomous mobile robot and capable of accommodating an article, a cleaning robot mechanically connectable to the other type of autonomous mobile robot, a patrol robot mechanically connectable to the other type of autonomous mobile robot, a transport robot capable of traveling along with the other type of autonomous mobile robot and including a wagon capable of accommodating an article, a cleaning robot capable of traveling along with the other type of autonomous mobile robot, and a patrol robot capable of traveling along with the other type of autonomous mobile robot.

4. An information providing method for a computer to provide information about an autonomous mobile robot, the information providing method comprising:
receiving input information including information about a plurality of robot accessory units that enables the autonomous mobile robot to execute a plurality of different services when used in combination with the autonomous mobile robot, information about a plurality of robot accessory units that enables another type of autonomous mobile robot to execute a plurality of different services when used in combination with the other type of autonomous mobile robot, information about a location and a time zone in which the autonomous mobile robot or the other type of autonomous mobile robot operates, and information about a type of a service requested;
performing a first calculation process of calculating first resource information based on the input information, the first resource information being information about a resource amount for the autonomous mobile robot and the robot accessory units required for a service;
performing a second calculation process of calculating second resource information based on the input information, the second resource information being information about a resource amount for the other type of autonomous mobile robot and the robot accessory units required for a service; and
outputting a result calculated by the first calculation process and the second calculation
